(19) United States
(12) Patent Application Publication
(10) Pub. No.: US 2005/0177519 A1
(43) Pub. Date: Aug. 11, 2005

(54) Game world operating system

(76) Inventor: Robert S. Block, Reno, NV (US)

Correspondence Address: BURNS DOANE SWECKER & MATHIS L L P, POST OFFICE BOX 1404, ALEXANDRIA, VA, 22313-1404, US

(21) Appl. No.: 11/025,597

(22) Filed: Dec. 30, 2004

Related U.S. Application Data
(60) Provisional application No. 60/532,915, filed on Dec. 30, 2003.

(51) Int. Cl. G06F 17/60

(52) U.S. Cl. 705/65

(57) ABSTRACT

An exemplary method for a commercial entity to provide goods and services in exchange for private currency includes providing a customer with private currency in exchange for government currency, wherein the private currency is acceptable to the commercial entity to pay for goods and services provided by the commercial entity, and providing a good and/or service to the customer in exchange for an amount of the private currency, wherein the commercial entity does not provide government currency to the customer in exchange for an amount of private currency.

This application claims priority from U.S. Provisional Application No. 60/532,915 which was filed in the U.S. Patent and Trademark Office on 30 Dec. 2003. U.S. Provisional Application No. 60/532,915 is hereby incorporated by reference.

### BACKGROUND INFORMATION

The Redemption Gaming industry typically operates as follows: Customers play games and to the extent they win (don't lose all their money) they can exchange tickets or points for prizes. The prizes are chosen from a limited selection offered by the same company that operated the games. Most of the prizes are low cost products. Many are the same as prizes offered at Carnivals in their Game Arcades. Exemplary prizes include stuffed dolls, stuffed animals, a hair dryer, etc. The winnings typically cannot be used to pay for a meal, only to select from a display of prizes.

### SUMMARY

An exemplary method for a commercial entity to provide goods and services in exchange for private currency includes providing a customer with private currency in exchange for government currency, wherein the private currency is acceptable to the commercial entity to pay for goods and services provided by the commercial entity, and providing a good and/or service to the customer in exchange for an amount of the private currency, wherein the commercial entity does not provide government currency to the customer in exchange for an amount of private currency.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and

FIG. 1 illustrates an exemplary method.

FIG. 2 illustrates an exemplary method.

FIG. 3 illustrates an exemplary method.

FIG. 4 illustrates an exemplary embodiment.

### DETAILED DESCRIPTION

In an exemplary embodiment, facilities wherein a private currency may be used, can be styled in the tradition of Hollywood and Las Vegas to provide visitors with an exciting high-tech environment and deliver world class entertainment, shopping, restaurants and night life, resort and game facilities. These facilities can be fully integrated, and can include live entertainment venues, themed restaurants & bars, movie theaters, large-format 4-D theater, virtual experiences, exhibitions, night club(s), disco/dancing facilities, food courts, and so forth. Age-group specific facilities or facility sections can also be provided, for example a “Kid'sWorld” where young children can learn and play and a “SportsWorld” for teens and young adults.

Shopping areas within the facilities can include retail stores and services covering all or any consumer product categories. The resort areas within the facilities can include one or more international hotel resorts with all their attendant facilities and amenities. A group of executive homes can be built within the resort area. The game areas within the facilities can be similar to those found in major Las Vegas Hotels. However, all equipment and games will be customized so that the games can be played only with prize points or currency that is valid only within the facilities. Shopping, resort, game, entertainment and other portions of the facilities can be separated, integrated, intermingled, intermixed, or otherwise organized, in any fashion.

As used herein, “facilities” can include one or more stores, restaurants, and gaming establishments or machines, which can be geographically co-located or geographically distributed, and which can be physical locations that a customer visits (“brick and mortar”) or can be virtual locations, for example a collection of shopping, entertainment, and gaming opportunities or interfaces/mechanisms accessible via one or more websites, URLs (Uniform Resource Locaters) and/or world-wide-web addresses. The facilities can be geographically co-located and integrated, or can be geographically distributed. The facilities can be controlled or owned by a single franchise brand with facilities in different parts of the world, or can be variously and separately owned. The facilities can be formed by multiple installations (geographically or virtually co-located, or geographically or virtually distributed) under different ownership but associated by common agreement, all of which honor one or more of the same non-government currency or currencies. The facilities can also be referred to as a commercial entity.

As used herein, “private currency” and “local currency” denote a non-government currency that is valid to purchase goods and services (including participation in games of chance and/or skill, which can provide winnings in the form of the private currency) within or via the facilities, for example at any vendor within or associated with the facilities. In an exemplary embodiment, the private currency is not recognized as legal tender by the government having legal jurisdiction over the facilities. Private currency can be referred to as “prize points”, or any term identifying a value redeemable for goods and services at participating vendors.

As used herein, “government currency” denotes a monetary currency recognized by a national government, for example US dollars, Japanese yen, German marks, and so forth. The government currency may be represented in different forms, including cash, usable balance on a credit card or debit card, personal check, and so forth.

In an exemplary embodiment, a facilities customer can only exchange private currency of the facilities only for goods and/or services (including games of skill and/or chance), for example goods and services at or through the facilities, and may not exchange the private currency for government currency (e.g. US dollars, German marks, Japanese yen, etc.). In other words, in an exemplary embodiment a customer may receive private currency in return for government currency, and may receive goods and/or services in return for private currency. However, the customer may not receive government currency in exchange for private currency, and may not receive goods and services (other than private currency) in exchange for government currency.

In an exemplary embodiment, the facility currency or point total is electronically stored, for example on a card and/or on a computer system accessible within the facilities. In an exemplary embodiment, some or all of the goods and services (including games of skill and/or chance) available in the facility, can be purchased by selected groups of people (e.g., visitors) with the facility currency or prize points. Different levels or classes of access can be provided to goods and services within the facilities—in one class all goods and services within the facilities are purchasable only with the facility currency, in another class selected goods and/or services are purchasable only with the facility currency. The identity of an individual can be associated with a particular class or classes of access, and/or a particular type of facility can be associated with a particular class or classes of access. Thus for example children or young adults can have a different class than adults, based either on personal identity linked to an electronic account of facility currency, or by having only “kid currency” or “teenage currency” to spend within the facilities. Thus in exemplary embodiments a balance or amount of private currency can be accessed by a customer presenting a card bearing information regarding the balance, for example a card containing data in electronic, magnetic or other machine-readable form, plain or encrypted. Additionally or alternatively, a customer can access a balance of private currency by presenting proof of personal identity (e.g. biometric data such as voiceprint, fingerprint, retinal scan, signature, or other identification such as driver's license, passport, and so forth) and/or information identifying the account (e.g. an account number, and/or a personal identification number (PIN) or password associated with the account, a decryption code or key, etc.). The account or balance information can be contained on a card or other physical medium accompanying the customer. In addition or alternatively, the account or balance information can be contained in a computer system accessible to the customer and/or the facility or portion thereof at which the customer seeks to exchange private currency for a good or service.

Services provided in the facilities can include video games, dealer games, non-dealer games, sport games, skill games, board games, arcade games, card and other games where the players deal and compete with each other, or any other game involving one or more of skill, chance, and social interaction. The games can provide winnings in the form of goods, services, and/or private currency that is valid for purchasing goods and services within or through the facilities.

In an exemplary embodiment, establishments within the facilities such as retailers, restaurants and entertainment venues subsidize the gaming activities in order to attract potential customers to the facilities and improve the chances of customers spending private currency in those establishments.

The facilities can be located within governmental jurisdictions that allow games of chance to be played only for prizes that are not government currency.

In an exemplary embodiment, customers can purchase private currency using cash, a credit card, debit card or other convenient payment whereby government currency or other currency recognized by the facilities, is exchanged for private currency. Customers can then use the purchased private currency any private currency winnings (e.g. from games of skill and/or chance) to purchase good or service available within the facilities.

In an exemplary embodiment, an operating system includes a real-time computer system connected to all games, currency card readers, dispensers and registers located throughout the facilities. The system tracks the purchase and disposition of the private currency. When a customer purchases a card having a balance or amount of private currency, the system records the amount of private currency purchased. If the customer increases the balance by purchasing more private currency, winning games, or returning a purchased product, the transaction will be recorded in a database of the computer system. Likewise, when a card or account balance of private currency is decreased as a result of purchases or game losses within the facilities, the transaction will be recorded in the computer database in real-time. At any given moment the computer system will “know” the balance of private currency in every account and/or on every card. Standard, personalized and specialty cards can be made available to customers. Special bonuses, offers, goods and/or services may be made available to customers that have standard, personalized or specialty cards. Specialty cards can for example be gift cards, cards that are valid only within a certain time window (e.g. day of the week, time of day, month, etc.), or have some other special characteristic.

In an exemplary embodiment, multiple registers are used to track the private currency balance(s) or activity of a customer. For example, three registers can be provided, wherein the first register is used to record the cash purchase of private currency, where the cash is a government currency (e.g., US dollars, Japanese yen, etc.). The first register is never decremented. The second register is used to record the purchase of goods or services with the private currency, and is never decremented. Each time a customer purchases a product or service using a private currency, the purchase is added to the balance in the second register. The third register is used to record net game winnings and losses—winnings are added to the third register, and losses are subtracted from the third register. A net amount of private currency available to the customer is equal to the balance of the first register added to the balance of the third register, less the balance of the second register.

In another embodiment, four registers are provided. The first register is used to record the cash purchase of private currency, where the cash is a government currency (e.g., US dollars, Japanese yen, etc.). The first register is never decremented. The second register is used to record the purchase of goods or services with the private currency, and is never decremented. Each time a customer purchases a product or service using a private currency, the purchase is added to the balance in the second register. The third register is used to record game winnings, and is never decremented. The fourth register is used to record game losses, and is never decremented. Net game winnings are equal to the third register less the fourth register, and conversely, net game losses are equal to the fourth register less the third register. A net amount of private currency available to the customer is equal to the balance of the first register added to the balance of the third register, less the balances of the second and fourth registers.

An exemplary objective of using multiple registers is to be able to differentiate between the private currency purchased with government currency, private currency spent in the purchase of goods and services, and private currency won or lost playing games. More or fewer than four Registers can be used to achieve this objective. For example, a single register can be used, that simply indicates a net balance available to the customer. Winnings and purchases of private currency can be added to the single register, and redemption of the private currency for goods and/or services (including gaming) can be debited from the register balance. Each of the techniques described here with respect to one or more registers can be used with exemplary embodiments and methods described herein, including both those which allow a customer to exchange some or all private currency for government currency, and those which do not.

In an exemplary embodiment, participation in a game can be purchased using private currency, and winnings from the game can be provided to the customer in the form of private currency and/or government currency. In another embodiment, a customer may exchange private currency for government currency. The exchange rates for the customer from government currency to private currency can be different (non-reciprocal) from an exchange rate from private currency to government currency, e.g. the customer can be effectively charged a fee for the exchange. In an exemplary embodiment, the cost of goods and services in the facilities can be structured so that the real cost of a good or service in private currency is different (more expensive or less expensive, depending for example on how the customer obtains the private currency, on incentives the facilities or vendors therein desire to provide, and so forth) from the cost in government currency. For example, a vendor can provide multiple prices for a good or service, each price corresponding to a different private currency or government currency, and the real value of those prices can differ. In another exemplary embodiment, a customer is allowed to exchange only some but not all private currency for government currency. For example, exchange of private currency for government currency may be allowed for a customer up to an amount of private currency that the customer initially purchased with government currency, but private currency game winnings beyond that amount may not be redeemed for government currency, but only for goods and services within or through the facilities.

Some venues may have a restriction such that private currency or prize points will never be exchanged for cash under any circumstances. Some venues may permit the conversion to government currency of any Points up to an amount of government currency used to purchase the Points

Still other venues may allow only a difference between the purchased private currency and private currency used to purchase goods and services, to be exchanged for government currency (e.g., no cash repayment of government currency for private currency won playing games).

An exemplary business method is directed to a local or private currency that is valid within a realm or local domain, e.g., “facilities” as defined herein, a local geographic area, and/or discrete group of vendors. Consumers purchase amounts of the local or private currency (e.g. “points”) that can then be used (lost or increased) in selected games of chance and/or skill, and can also be used to purchase goods or services at participating vendors. For example, the method can be implemented at a shopping center that includes a casino or game center where customers exchange a national or government currency (e.g. US dollars) for an amount of a currency local to the shopping center (“points”) that can be spent only in the casino and in vendor stores (restaurants, retailers) within the shopping center. The local domain, e.g. shopping center, will not exchange or convert the local currency to a national currency for a customer. In an exemplary embodiment, a computer system is provided for tracking in real time the distribution and transfer of the points or local currency within the realm or facilities where the local currency is valid, and a system for allowing the participating vendors to exchange received local currency for a national currency or other commercially valuable medium is also provided.

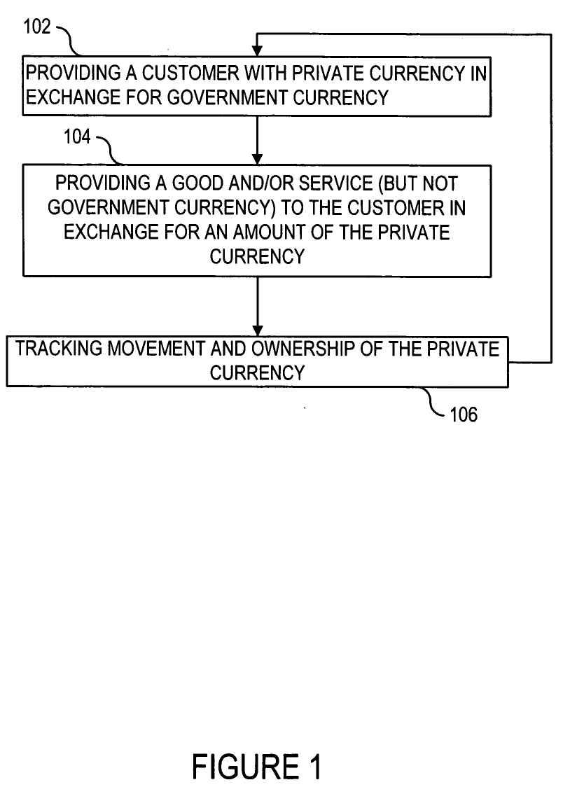

FIG. 1 illustrates an exemplary method consistent with the various features and techniques described herein. In a first block 102, a customer is provided with private currency in exchange for government currency. In a next block 104, a good and/or service is provided to the customer in exchange for an amount of the private currency. As described herein, the private currency is not redeemable by the customer for government currency. From block 104, control proceeds to block 106, where movement and ownership of private currency, for example within a set of facilities, is tracked. This tracking can be performed, for example, by the computer system described herein.

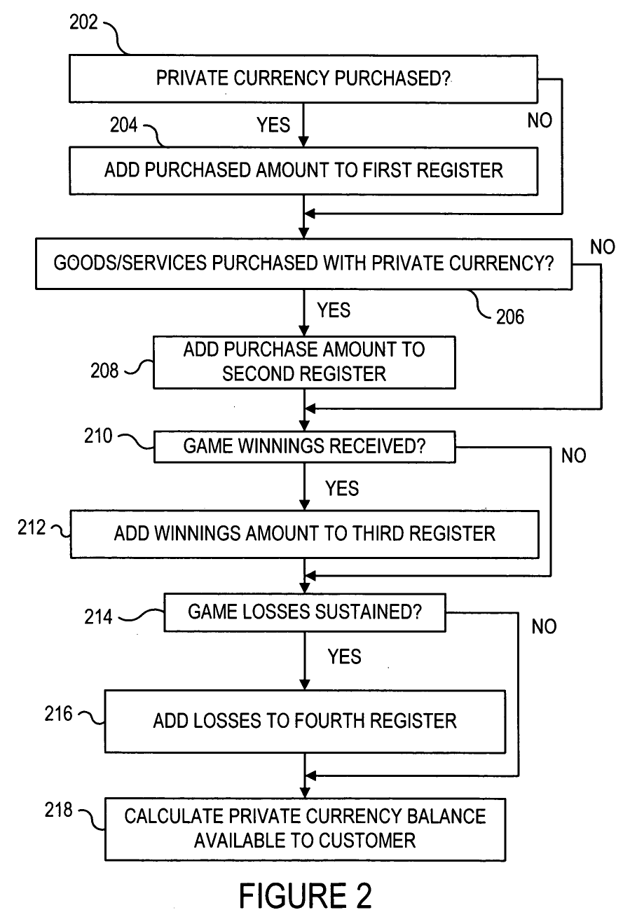

FIG. 2 illustrates an exemplary method of handling or tracking private currency associated with a customer or a customer's account, using four registers, consistent with the various features and techniques described herein. In a first block 202, a determination is made whether the customer has purchased or has been given an amount of private currency. If not, then control proceeds to block 206. If yes, then control proceeds to block 204, where the amount is added to a first register. From block 204, control proceeds to block 206, where a determination is made whether the customer has purchased goods and/or services with private currency. If not, then control proceeds to block 210. If yes, then control proceeds to block 208, where the amount of the purchase is added to a second register. From block 208 control proceeds to block 210, where a determination is made whether the customer or entity associated with the account has received game winnings. If not, then control proceeds to block 214. If yes, the control proceeds to block 212, where the amount of the winnings is added to a third register. From block 212 control proceeds to block 214, where a determination is made whether the customer or entity associated with the account has sustained gaming losses. If not, then control proceeds to block 218. If yes, then control proceeds to block 216, where the amount of the losses is added to a fourth register. From block 216, control proceeds to block 218 where a private currency balance available to the customer for the account is calculated. The available balance can be calculated as equal to the sum of the first and third register balances less the balances of the second and fourth registers. From block 218, the process can end or control can return to block 202 to continue the process indefinitely.

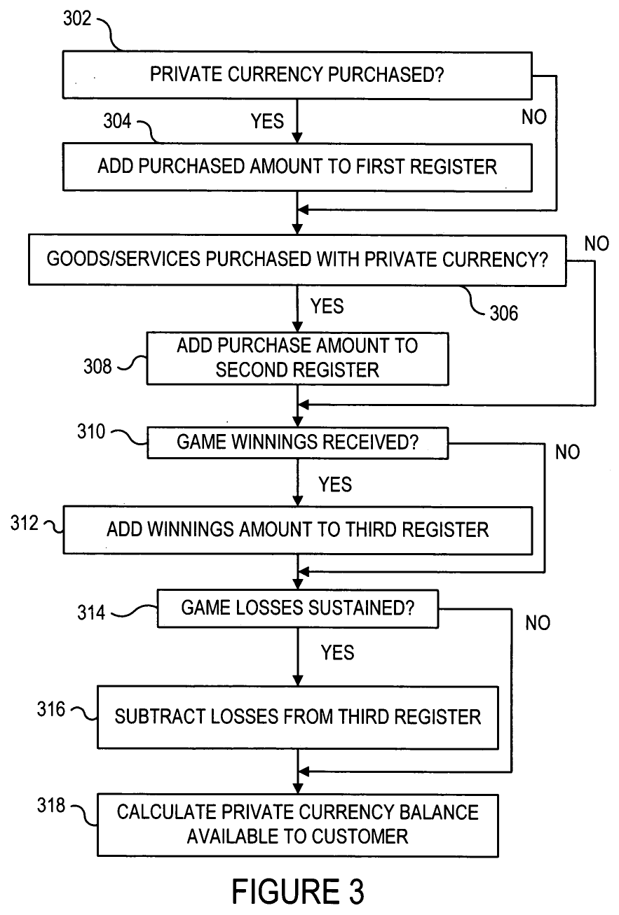

FIG. 3 illustrates an exemplary method of handling or tracking private currency associated with a customer or a customer's account, using three registers, consistent with the various features and techniques described herein. In a first block 302, a determination is made whether the customer has purchased or has been given an amount of private currency. If not, then control proceeds to block 306. If yes, then control proceeds to block 304, where the amount is added to a first register. From block 304, control proceeds to block 306, where a determination is made whether the customer has purchased goods and/or services with private currency. If not, then control proceeds to block 310. If yes, then control proceeds to block 308, where the amount of the purchase is added to a second register. From block 308 control proceeds to block 310, where a determination is made whether the customer or entity associated with the account has received game winnings. If not, then control proceeds to block 314. If yes, the control proceeds to block 312, where the amount of the winnings is added to a third register. From block 312 control proceeds to block 314, where a determination is made whether the customer or entity associated with the account has sustained gaming losses. If not, then control proceeds to block 318. If yes, then control proceeds to block 316, where the amount of the losses is subtracted from the third register. If net losses exceed net winnings, the third register can have a negative balance. From block 316, control proceeds to block 318 where a private currency balance available to the customer for the account is calculated. The available balance can be calculated as equal to the sum of the first and third register balances less the balances of the second register. From block 318, the process can end or control can return to block 302 to continue the process indefinitely.

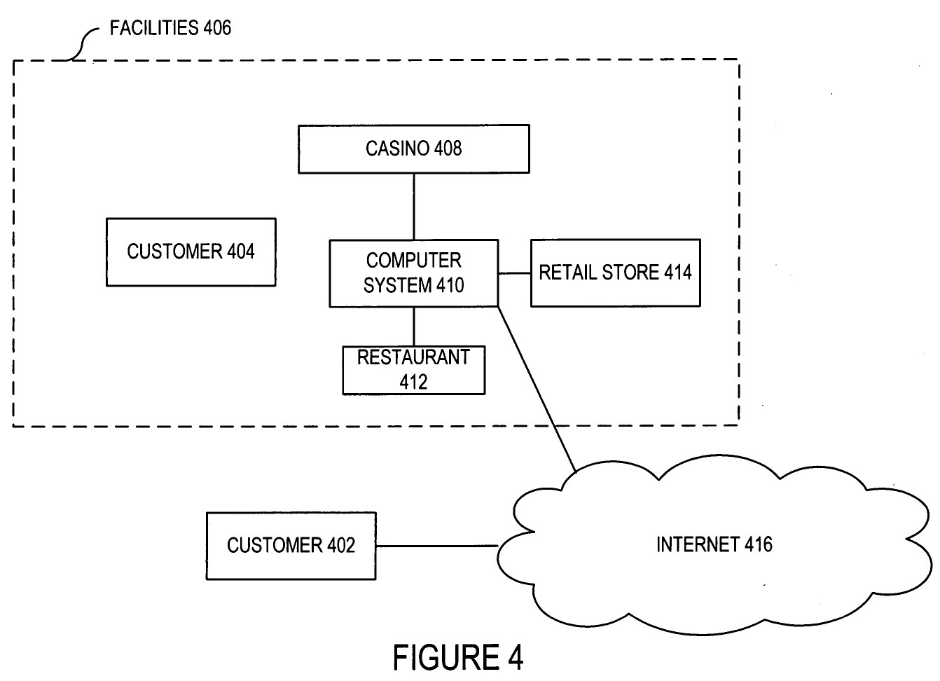

FIG. 4 illustrates an exemplary embodiment, consistent with the various features and techniques described herein. In particular, FIG. 4 shows facilities 406 including a casino 408, a retail store 414, and restaurant 412, all connected to a computer system 410 having the functions and capabilities described herein. A customer 404 is shown on the campus of the facilities 406, and another customer 402 is shown in virtual connection with the facilities via a network 416 such as the Internet or world-wide-web. The facilities 406 can include any of the resources and functions described herein with respect to facilities, and can accommodate multiple real and virtual customers.

Software packages, elements or modules for variously providing access or views to databases and for gathering and/or processing information as described herein, can be implemented on the computer. These software processes running on the computer can additionally or alternatively be implemented in a distributed fashion external to the network using for example distributed computing resources, and/or can be implemented using resources of the network.

The methods, logics, techniques and pseudocode sequences described herein can be implemented in a variety of programming styles (for example Structured Programming, Object-Oriented Programming, and so forth) and in a variety of different programming languages (for example Java, C, C++, C#, Pascal, Ada, and so forth). In addition, those skilled in the art will appreciate that the elements and methods or processes described herein can be implemented using a microprocessor, computer, or any other computing device, and can be implemented in hardware and/or software, in a single physical location or in distributed fashion among various locations or host computing platforms. Agents can be implemented in hardware and/or software or computer program(s) at any desired or appropriate location. Those skilled in the art will also appreciate that software or computer program(s) can be stored on a machine-readable medium, wherein the software or computer program(s) includes instructions for causing a computing device such as a computer, computer system, microprocessor, or other computing device, to perform the methods or processes.

A machine readable medium can include software or a computer program or programs for causing a computing device to perform the methods and/or techniques described herein.

It will also be appreciated by those skilled in the art that the present invention can be embodied in other specific forms without departing from the spirit or essential characteristics thereof, and that the invention is not limited to the specific embodiments described herein. The presently disclosed embodiments are therefore considered in all respects to be illustrative and not restrictive. The scope of the invention is indicated by the appended claims rather than the foregoing description, and all changes that come within the meaning and range and equivalents thereof are intended to be embraced therein.

1. A method for vendors to provide goods and services in exchange for private currency, comprising:
providing a customer with private currency in exchange for government currency, wherein the private currency is acceptable to the vendors to pay for goods and services provided by the commercial entity; and
each of the vendors providing a good and/or service to the customer in exchange for an amount of the private currency.

2. The method of claim 1, wherein the services include participation in games provided via the vendors.

3. The method of claim 2, wherein the services provided to the customer include game winnings provided in the form of the private currency.

4. The method of claim 1, wherein the vendors do not provide government currency to the customer in exchange for an amount of private currency.

5. The method of claim 1, wherein the vendors are located at different geographic locations.

6. The method of claim 3, wherein the vendors are accessed by the customer via the Internet.

7. The method of claim 3, wherein the vendors use a computer system that tracks movement and ownership of the private currency and the method comprises tracking movement and ownership of the private currency.

8. The method of claim 7, Wherein the computer system tracks the movement and ownership of the private currency via at least one register.

9. The method of claim 7, wherein the computer system provides, for each customer account:
a first register that records any purchase of the private currency by the customer for deposit to the account;
a second register that records the purchase of goods and services with private currency from the account;
a third register that records an amount of private currency corresponding to game winnings of the customer; and
a fourth register that records an amount of private currency corresponding to game losses of the customer.

10. The method of claim 9, wherein an amount of private currency available to the customer is equal to the sum of the third and first registers less the values of the fourth and second registers.

11. The method of claim 7, wherein the computer system provides, for each customer account:
a first register that records any purchase of the private currency by the customer for deposit to the account;
a second register that records the purchase of goods and services with private currency from the account;
a third register that records an amount of private currency corresponding to net game winnings and losses of the customer, wherein game winnings are added to the third register, and game losses are subtracted from the third register.

12. The method of claim 11, wherein an amount of private currency available to the customer is equal to the sum of the third and first registers less the values of the second register.

13. The method of claim 1, wherein the commercial entity comprises multiple vendors at a single geographic location.

14. The method of claim 1, wherein the facility provides the customer with government currency in exchange for private currency up to a specified amount of private currency.

15. The method of claim 14, wherein the specified amount equal to an amount of private currency that the customer purchased with government currency.

16. The method of claim 1, wherein information regarding an amount of private currency available to the customer is stored on a customer-portable medium.

17. The method of claim 1, wherein the customer-portable medium is machine readable.

18. A system for providing goods and services in exchange for private currency, comprising:
facilities including vendors providing goods and services to a customer in exchange for private currency; and
a computer system that tracks movement and ownership of the private currency with respect to transactions between the vendors and customers.

19. The system of claim 18, wherein the services include participation in games provided via the facilities.

20. The system of claim 19, wherein the services provided to the customer include game winnings provided in the form of the private currency.

21. The system of claim 20, wherein the facilities comprise multiple vendors at a single geographic location.

22. The system of claim 20, wherein the facilities comprise multiple vendors at distributed geographic locations.

23. The system of claim 20, wherein the facilities are accessed by the customer via the Internet.

24. The system of claim 18, wherein the facilities do not provide government currency to the customer in exchange for an amount of private currency.

25. The system of claim 18, wherein the facility provides the customer with government currency in exchange for at least some of the customer's private currency.

26. The system of claim 25, wherein the facility provides the customer with government currency in exchange for up to an amount of private currency that the customer purchased with government currency.
